(19) United States
(12) Patent Application Publication
(10) Pub. No.: US 2025/0144832 A1
(43) Pub. Date: May 8, 2025

(54) BEARING TYPE HANDLE ROLLER CUTTER

(71) Applicant: Specialty Product Sales, Inc, Gainesville, GA (US)

(72) Inventors: Liao Haiping, Dongguan City (CN); Brint Fanizza, Gainesville, GA (US)

(73) Assignee: Specialty Product Sales, Inc, Gainesville, GA (US)

(21) Appl. No.: 18/503,742

(22) Filed: Nov. 7, 2023

(51) Int. Cl. B26B 25/00

(52) U.S. Cl. CPC B26B 25/005

(57) ABSTRACT

A bearing type handle roller cutter is disclosed. The bearing type handle roller cutter comprises a handle body, and a movable bracket movably connected within the handle body. The handle body utilises a push block, a spring, a bearing, a protective disk and a cutter head, and exposes the cutter head for cutting. The push block is pushed through the use of the spring to automatically reset and protect the cutter head. The bearing type handle roller cutter can be used by different people and has the advantages of prolonging the service life and improving the cutting accuracy.

### FIELD

The present disclosure relates to a technical field of handle roller cutters, in particular to a bearing type handle roller cutter.

### BACKGROUND

Handle roller cutters are widely used for cutting needs. A conventional roller handle cutter generally rotates by friction between a blade and a handle shaft. The roller handle cutter is designed to accommodate human factors that address the different ways people use the roller handle cutter. Depending on user's physical abilities, the roller handle cutter may be used with varying downward pressure to the cutting surface, which may result in varying friction between the blade and a screw rod, different degrees of natural wear, and varying friction between a hook groove and screw rod. The varying pressures in use often result in an unpredictable service life of the conventional roller handle cutter and can adversely affect cutting accuracy and material waste. These factors may reduce the practicability of the handle roller cutter and cause inconvenience to the users.

### SUMMARY

In view of the problems existing in the prior art, the utility model or the present disclosure provides a bearing-type handle roller cutter, which has the advantages of improving service life and cutting accuracy and addresses the deficiencies of conventional roller handle cutter knife systems having a roller that rotates axially through the friction fit between the blade and the handle shaft.

The utility model or the present disclosure is realized in the following way. The bearing-type handle roller cutter includes a handle body, the inside of the handle body is movably connected with a movable bracket, the bottom of the inner cavity of the handle body is provided with a rigid frame, and the rear side of the fixed frame is fixedly connected to a fixed tube. The rear side of the movable bracket is fixedly connected with a push block, the bottom of the movable bracket is fixedly connected with a protective disk, the front side of the protective disk is movably connected with a cutter disk or cutter head, and the rear of the cutter disk is fixedly connected to a bearing. The rear side of the bearing extends and penetrates into the inner cavity of the fixed tube, and an outer ring of the bearing is fixedly connected with the cutter head. The front side of the rigid frame is movably connected with a first fixed cap, and the rear side of the protective disk is movably connected with a second fixed cap.

In one embodiment, the opposite sides of the first fixed cap and the second fixed cap both extend to the inner ring of the bearing and are movably connected by threads.

In one embodiment, the rear side of the protective disk is provided with a moving hole for use with a fixed tube, and the rear side of the fixed tube passes through the moving hole and extends to the rear side of the protective disk.

In one embodiment of the present disclosure, the rear side of the handle body is provided with a movable hole used in conjunction with the movable bracket, and the rear side of the movable bracket passes through the movable hole and extends to the rear side of the handle body.

In one embodiment of the present disclosure, the top of the movable bracket is fixedly connected with a spring, and the top of the spring is fixedly connected with the top of the inner wall of the movable hole.

Compared with the prior art, the beneficial effects of the present disclosure are as follows:
The utility model or the present disclosure uses the handle body, the push block, the spring, the bearing, the protective disk and the cutter head in cooperation. The push block is pushed to expose the cutter head for cutting. The spring helps to push the movable bracket and reset after cutting. The automatic reset protection solves the deficiencies of conventional roller handle cutters whereby it rotates through the friction between the blade and the handle shaft. The bearing-type handle roller cutter with the advantages of improved service life and cutting accuracy.

In the utility model or the present disclosure, the bearing and the cutter head can be limited by arranging the first fixed cap and the second fixed cap, and the cutter head can be quickly installed and uninstalled by disassembling the first fixed cap and the second fixed cap.

The utility model or the present disclosure is provided with a sealed bearing that limits the moving range of the protective disk during the moving process of the protective disk, thereby avoiding the phenomenon of jamming the protective disk.

By setting the movable hole, the movable bracket drives to move in the inner cavity of the movable hole during the movement of the push block, which ensures the smoothness of the movable bracket when moving, and facilitates the user to adjust the position of the protective disk.

By setting the spring, the movable bracket drives the spring to be elastically deformed. The movable bracket can be automatically reset by the spring deformation, so that the cutter head can be automatically reset, which ensures that the cutter head is protected from accidentally touches and improves the safety.

### BRIEF DESCRIPTION OF THE DRAWINGS

FIG. 1 is a schematic diagram of the bearing-type handle roller cutter, in accordance with one embodiment of the present disclosure;

FIG. 2 is a front view of the bearing-type handle roller cutter, in accordance with one embodiment of the present disclosure;

FIG. 3 is a schematic diagram of the internal structure of the handle body, in accordance with one embodiment of the present disclosure;

FIG. 4 is a partial rear cross-sectional view of the handle body, in accordance with one embodiment of the present disclosure; and

FIG. 5 is a bottom cross-sectional view of the handle body, in accordance with one embodiment of the present disclosure.

### DETAILED DESCRIPTION

In order to further understand the content, features, and effects of the present disclosure, the following embodiments are exemplified, and detailed descriptions are given below in conjunction with the accompanying drawings.

The features of the present disclosure will be described in detail below in conjunction with the accompanying drawings.

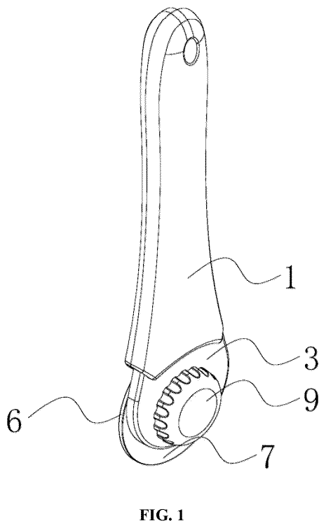

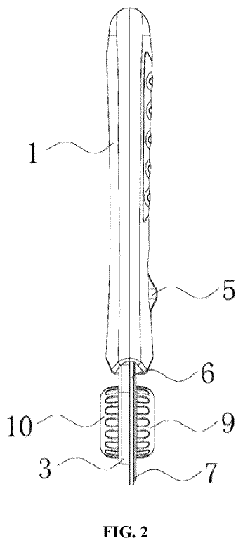

FIGS. 1 through 5 show a bearing-type handle roller cutter comprising a handle body 1, in accordance with embodiments of the present disclosure. The handle body 1 comprises a movable bracket 2. The movable bracket 2 is movably connected at an inside of the handle body 1. The bearing-type handle roller cutter comprises a fixed frame 3 positioned at the bottom of the inside or inner cavity of the handle body 1. The bearing-type handle roller cutter comprises a fixed tube 4. The fixed tube 4 is connected at a rear side of rigid frame 3. The bearing-type handle roller cutter comprises a push block 5. The push block 5 is connected at a rear side of the movable bracket 2.

Further, the movable bracket 2 comprises a protective plate or protective disk 6. The protective disk 6 is positioned at the bottom of the movable bracket 2. The protective disk 6 comprises a cutter head or cutter plate 7. The cutter head 7 is movably connected to the protective disk 6 at a front side of protective disk 6. The cutter head 7 comprises a bearing 8. The bearing 8 connects to the cutter head 7 at a rear side of the cutter head 7. The rear side of the bearing 8 extends and runs through an inner cavity of the fixed tube 4. Here, an outer ring of the bearing 8 is fixedly connected with the cutter head 7. Further, the front side of the rigid frame 3 is movably connected with a first fixed cap 9, and a rear side of the protective disk 6 is movably connected to a second fixed cap 10.

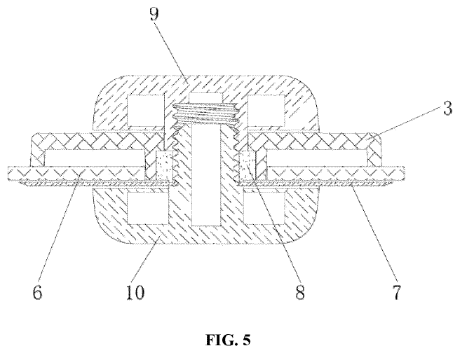

Referring to FIG. 5, the first fixed cap 9 and the second fixed cap 10 both extend from the opposite sides of the inner ring of the bearing 8 and are movably connected by threads is shown, in accordance with one embodiment of the present disclosure.

The bearing 8 and the cutter head 7 are secured with the help of the first fixed cap 9 and the second fixed cap 10. The cutter head 7 is installed or removed by disassembling/uninstalling the first fixed cap 9 and the second fixed cap 10.

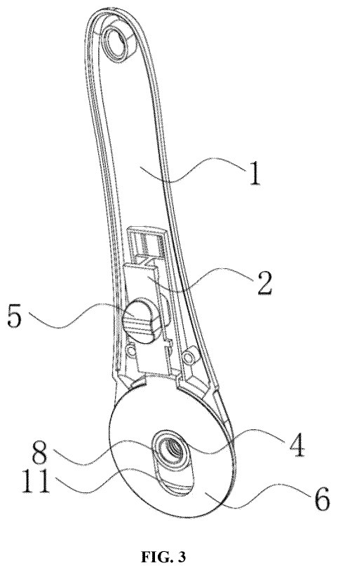

Referring to FIG. 3, the bearing-type handle roller cutter comprising a moving hole 11 is shown. The moving hole 11 positions at the rear side of the protective disk 6 and the fixed tube 4. The rear side of the fixed tube 4 passes through the moving hole 11 and extends to the rear side of the protective disk 6.

The moving hole 11 is provided to limit/present a moving range for the protective disk 6 such that the protective disk 6 does not get stuck/jammed during the operation.

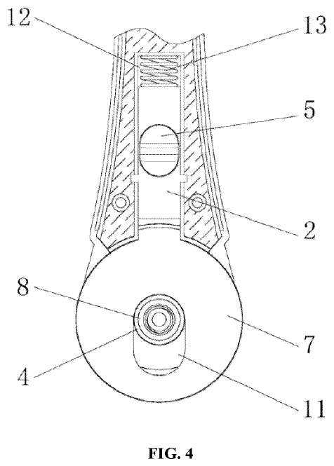

Referring to FIG. 4, the handle body 1 comprising a movable hole 12 is shown. The movable hole 12 positions at the rear side of the handle body 1 and helps in operating the movable bracket 2. Here, the rear side of the movable bracket 2 passes through the movable hole 12 and extends to the rear side of the handle body 1.

The movable hole 12 receives the movable bracket 2. In operation, the push block 5 is pushed to move the movable bracket 2 within the movable hole 12. The movable bracket 2 moves smoothly in the movable hole 12 and facilitates in adjusting the position of the protective disk 6.

Referring to FIG. 4, the movable bracket 2 comprising a spring 13 at the top is shown. The spring 13 positions in the movable hole 12 and one end of the spring 13 connects to the movable bracket 2.

The spring 13 allows the movable bracket 2 to drive along the movable hole 12. Here, the movable bracket 2 drives or pushes the spring 13 to undergo elastic deformation. The deformation of the spring 13 drives the movable bracket 2 to automatically reset, which in turn automatically resets the cutter head 7 to ensure that the cutter head 7 is not touched accidentally, thereby improving the safety.

In use, a user pushes the push block 5. Here, the push block 5 drives the movable bracket 2 to move synchronously. The movable bracket 2 drives the spring 13 to undergo elastic deformation. Concurrently, the movable bracket 2 drives the protective disk 6 to move until the cutter head 7 is exposed outside of the protective disk 6 and can be used for cutting. In addition, when the cutter head 7 is cutting, the cutter head 7 drives the outer ring of the bearing 8 to rotate. After the cutting is finished, the push block 5 is released such that the spring 13 drives the movable bracket 2 to reset, achieving the purpose of automatic reset of the protective disk 6 and protecting the cutter head 7 from being exposed. This improves the safety and convenience of the users to use the bearing-type handle roller cutter.

In summary: the bearing-type handle roller cutter comprising the handle body 1, the push block 5, the spring 13, the bearing 8, the protective disc 6 and the cutter head 7; and the cutter head 7 can be exposed for cutting by pushing the push block 5. The cutter head 7 is automatically reset and protected with the help of the spring 13.

The described embodiments of the present disclosure remedy the deficiencies of conventional cutters by structurally rotating and translating force through the friction between the blade and the handle shaft. Because users may use the cutter in various positions with different levels of strength and force, the degree of friction and natural wear between the blade and the screw rod is minimized. Further, the friction on the screw rod may increase the service life of the handle knife and increase cutting accuracy, which may reduce material waste caused by miscuts.

It should be noted that in this description, relational terms such as first and second are only used to distinguish one entity or operation from another entity or operation, and without necessarily requiring or implying one of these entities or operations. Further, the terms “including”, “comprising”, “comprise”, “include” or any other variants thereof are intended to cover non-exclusive inclusions, so that a process, method, article or device including a series of elements not only includes those elements, but also includes those that are not explicitly listed Other elements of, or also include elements inherent to this process, method, article or equipment.

Although the embodiments of the present disclosure have been shown and described, those of ordinary skill in the art can understand that various changes and modifications can be made to these embodiments without departing from the scope and spirit of the present disclosure. Replacements and modifications, the scope of the present disclosure is defined by the appended claims and their equivalents.

That which is claimed is:

1. A bearing type handle roller cutter, comprising:
a handle body;
a movable bracket movably connected within the handle body;
a rigid frame provided at the bottom of an inner cavity of the handle body;
a fixed tube connected to the rigid frame;
a push block connected to the movable bracket at a rear side of the movable bracket;
a protective disk connected at the bottom of the movable bracket;
a cutter head movably connected to the protective disk at a front side of the protective disk, wherein a rear side of the cutter head is connected to a bearing, wherein a rear side of the bearing extends and runs through an inner cavity of the fixed tube, and wherein the bearing comprises an outer ring connected to the cutter head;
a first fixed cap connected to the front side of the protective disk; and
a second fixed cap movably connected to a rear side of the protective disk.

2. The bearing type handle roller cutter of claim 1, wherein opposite sides of the first fixed cap and the second fixed cap extend to the outer ring of the bearing and pass through a threaded articulation.

3. The bearing type handle roller cutter of claim 1, wherein the rear side of the protective disk is provided with a moving hole used in conjunction with the fixed tube, and wherein the fixed tube passes through the moving hole and extends to the rear side of the protective disk.

4. The bearing type handle roller cutter of claim 1, wherein a rear side of the handle body is provided with a movable hole used in conjunction with the movable bracket, and wherein the movable bracket passes through the movable hole and extends to the rear side of the handle body.

5. The bearing type handle roller cutter of claim 4, wherein a top of the movable bracket is fixedly connected with a spring, and wherein a top of the spring is connected to an inner wall of the movable hole.
